(19) United States
(12) Patent Application Publication
(10) Pub. No.: US 2009/0057045 A1
(43) Pub. Date: Mar. 5, 2009

(54) HYDRAULIC SYSTEM TO DETER LIFT ARM CHATTER

(75) Inventors: Gary STROMBERG, Derby, KS (US); Adam EWING, Wichita, KS (US); John HARMS, Wichita, KS (US)

Correspondence Address: CNH AMERICA LLC;INTELLECTUAL PROPERTY LAW DEPARTMENT, P O BOX 1895, M.S. 641, NEW HOLLAND, PA, 17557, US

(73) Assignee: CNH AMERICA LLC, New Holland, PA (US)

(21) Appl. No.: 12/190,815

(22) Filed: Aug. 13, 2008

Related U.S. Application Data
(60) Provisional application No. 60/966,599, filed on Aug. 29, 2007.

(51) Int. Cl. B60K 25/00; F16D 31/02

(52) U.S. Cl. 180/165; 60/413

(57) ABSTRACT

A skid steer or wheel loader having an implement, such as a bucket, arranged for elevational and tilting movements relative to the frame of the loader has a foot controlled hydraulic system that deters lift arm chatter. An accumulator is directly connected to the conduit between the control valve, which controls raising and lowering of the implement, and the end chamber of the lift arm cylinder that raises the implement. The spool of the control valve is positioned by a mechanically linked foot pedal. The end chamber that lowers the implement is not connected to the hydraulic fluid supply reservoir when the control valve spool is in its neutral position, so that down pressure may be applied to the implement for ground penetration and deter lift arm chatter without having to turn the system on or off at appropriate times.

### RELATED APPLICATION

This application claims priority to U.S. Provisional Patent Application Ser. No. 60/966,599, filed Aug. 29, 2007, entitled “Skid Steer Attenuator to Prevent Lift Arm Chatter.”

### FIELD OF THE INVENTION

The present invention generally relates to off-highway equipment and, more particularly, to a hydraulic system used to position a suitable implement, such as a bucket, relative to the frame of an off-highway vehicle such as a skid steer or wheel loader, and more particularly to a hydraulic system and method to deter lift arm chatter of the lift arm to which the implement is attached.

### BACKGROUND OF THE INVENTION

A skid steer or wheel loader is commonly used to load and move substantial volumes of dirt and like material from one location to another. A conventional wheel loader includes a relatively large frame that is supported for self-propelled movement over land by pairs of air-filled pneumatic tires and has a bucket or implement mounted to one end thereof. The bucket or implement can be selectively elevated to a position above side panels on a wheel loader and can be selectively tilted to “dump” materials therefrom.

The bucket or implement is typically connected to forward ends of a pair of lift arms extending from and having opposite ends pivotally connected to the frame of the loader. The bucket is connected to the lift arms in a manner allowing tilting movement of the bucket about a generally horizontal axis.

Hydraulic cylinders generally provide the motive force for moving the bucket or implement. Typically, a pair of hydraulic cylinders is connected to the frame for pivoting the lift arms and thereby adjusting the elevation of the bucket. Another hydraulic cylinder tilts the bucket about its horizontal axis to dump the materials from the bucket.

Some machines control lift arm movement with a foot pedal that is connected to loader or lift arm control valve by a mechanical linkage. A quick movement of the lift arms, particularly with the loader valve spool in a mid-stroke position, can cause the front tires to deflect and the rebound similar to a spring. As the machine begins to bounce, the operator's foot can move relative to the foot pedal. This foot movement can lead to inadvertent stroking of the control valve spool that can quickly lead to a resonance condition resulting in uncontrolled lift arm jerky movement or lift arm chatter.

In an attempt to reduce the lift arm chatter, some wheel loaders have been known to include a mechanical damper or shock absorber to the loader valve control linkage to minimize movement of the pedal under these conditions. Use of such dampers or shock absorbers has been less than effective in some cases.

Thus, there is a need and a desire for a hydraulic system that deters lift arm chatter. Preferably, the system also allows the operator to apply down pressure on the bucket for ground penetration and deter arm lift chatter without having to turn the system on or off at the appropriate time.

Some wheel loaders include a ride control system to improve the ride of the vehicle over rough terrain. While this system includes an accumulator in the lift circuit, lift arm chatter is not an issue because the control valve is position by an electrically operated actuator. The system also has a 2-position 4-way valve to connect the accumulator to the base end chamber of the lift cylinder and the rod end chamber to the hydraulic reservoir or tank. Therefore, the operator must turn the system on and off by connecting and disconnecting the accumulator to the system.

### SUMMARY OF THE INVENTION

Other features and advantages of the present invention will be apparent from the following more detailed description of the preferred embodiment, taken in conjunction with the accompanying drawings which illustrate, by way of example, the principles of the invention.

In a preferred form of the invention, a hydraulic system vertically positions an implement relative to a frame of a vehicle. The hydraulic system includes a pressurized fluid source, a hydraulic cylinder, a reservoir for receiving excess fluid, a control valve for controlling flow of the pressurized fluid to the base end chamber or rod end chamber of the hydraulic cylinder, a conduit connecting the pressurized fluid source to the control valve, a conduit connecting the control valve to the reservoir, a conduit connecting the control valve to the base end chamber, a conduit connecting the control valve to the rod end chamber, and an accumulator. The accumulator is directly connected to the conduit connecting the control valve to the end chamber that controls raising of the implement.

The hydraulic cylinder raises the implement when fluid is directed to the base end of the cylinder and the pressure is increased to a level that will overcome the load. The implement is lowered when fluid in the base end of the cylinder is returned to tank and/or the pressure is increased on the rod end of the cylinder to a level that will overcome the load.

The invention also includes a wheeled vehicle in which the hydraulic system is installed. Further, the invention includes the method of deterring lift arm chatter of a wheeled vehicle having a lift arm and a vertically positionable implement attached to the lift arm by installing the hydraulic system in the wheeled vehicle.

Numerous other features and advantages of the present invention will become readily apparent from the following detailed description, the accompanying drawings, and the appended claims.

### BRIEF DESCRIPTION OF THE DRAWINGS

FIG. 1 is a schematic side elevational view of a skid steer or wheel loader equipped with a bucket or other suitable implement shown in various elevational and tilted positions and embodying the teachings of the present invention.

FIG. 2 is a diagrammatic view of a hydraulic system used in the skid steer or wheel loader of FIG. 1 and including the lift arm chatter deterring mechanism of the present invention.

### DETAILED DESCRIPTION OF THE INVENTION

While the present invention is susceptible of embodiment in various forms, there is shown in the drawings and will hereinafter be described a preferred embodiment of the present invention with the understanding that the present disclosure is to be considered as an exemplification of the invention that is not intended to limit the invention to the specific embodiment illustrated.

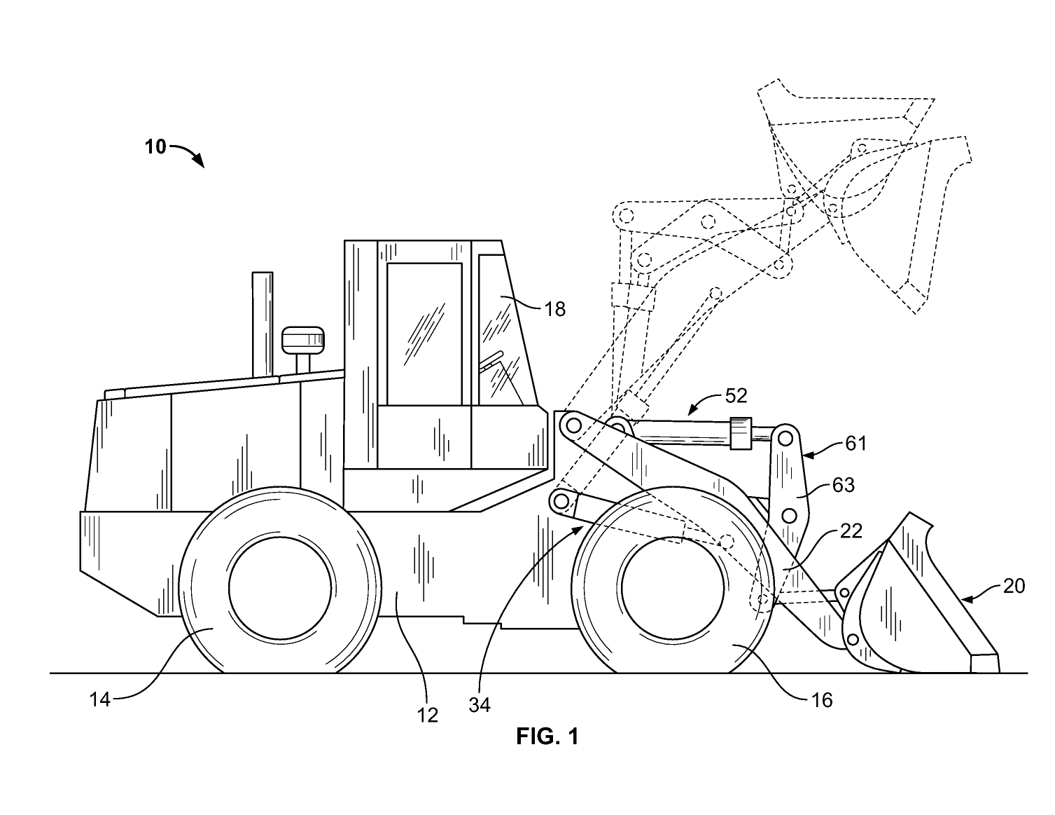

Referring now to the drawings, wherein like reference numerals refer to like parts in both views, there is schematically illustrated in FIG. 1 a skid steer or wheel loader 10, which is illustrative of the type of off-highway vehicle or equipment with which the present invention finds utility. Wheel loader 10 includes a relatively large frame 12 supported for self-propelled movement over terrain by pairs of air filled pneumatic tires 14, 16. A cab region or operator station 18 is provided intermediate fore-and-aft ends of the frame 12.

Wheel loader 10 further includes implement 20 connected to frame 12 for movement relative thereto. As shown, a pair of lift arms 22 (only one being shown) is each pivotally connected toward one end and on opposite sides of frame 12. The implement 20 is pivotally connected at the opposite end of lift arms 22 for tilting movement relative to the frame about a generally horizontal axis. The above-described features form no substantial part of the present invention and are generally well known in the art.

In accordance with the present invention, a hydraulic system 25 is provided for elevating and/or holding the implement 20 in different positions of adjustment relative to frame 12 and for tilting the implement 20 relative to frame 12 to “dump” materials therefrom. The hydraulic system 25 includes hydraulic lift circuitry for controlling elevation of the implement relative to the frame and hydraulic tilt circuitry for controlling tilting of the implement relative to the frame 12.

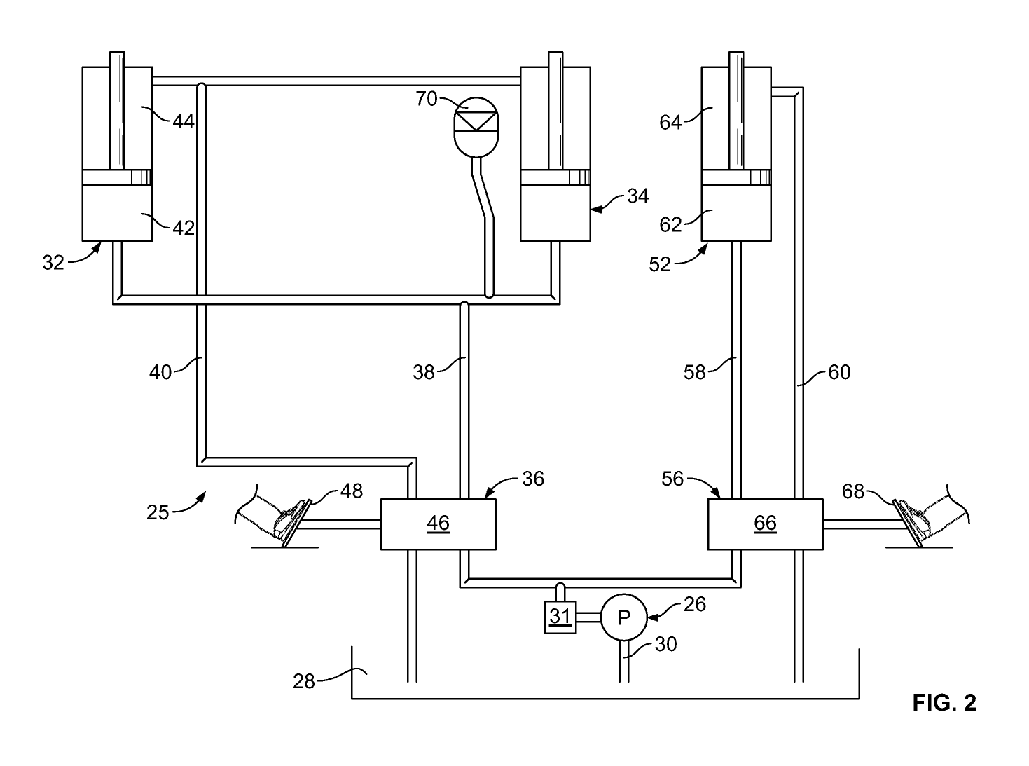

As shown in FIG. 2, both the lift and tilt circuitry of hydraulic system 25 are powered by a common fluid source such as a motor driven hydraulic pump 26 capable of producing fluid pressure levels in the fluid system in accordance with the operational requirements of the wheel loader. Pump 26 receives operating fluid from a supply tank or reservoir 28 through a supply conduit 30. In a preferred form of the invention, a pressure regulator 31 is provided intermediate pump 26 and the lift and tilt circuitry.

The lift circuitry of the hydraulic system includes hydraulic cylinders 32, 34 powered by the pump 26 and connected between frame 12 and the lift arms 22 for vertically positioning the implement 20 relative to the frame in response to fluid flow to the hydraulic cylinders. The hydraulic cylinders 32, 34 are selectively controlled by a control valve assembly 36, which is connected to the pump 26. Fluid conduits 38, 40 define a fluid flow path and serve to interconnect and direct pressurized fluid between the hydraulic cylinders 32, 34 and the control valve assembly 36.

As shown, the hydraulic cylinders 32, 34 are substantially similar to each other and, thus, only hydraulic cylinder 32 will be described in detail. In a preferred form, each hydraulic cylinder comprises a conventional linearly distendable fluid cylinder 32, 34 articulately connected between the frame 12 and each lift arm 22. Each hydraulic cylinder 32, 34 operates in response to fluid flows at respective head and rod end chambers 42, 44. In the illustrated embodiment, the volume of the fluid receiving chambers at opposite ends of each hydraulic cylinder 32, 34 controls the elevation or vertical disposition of the implement 20 relative to the frame 12.

Control valve assembly 36 is fluidly connected to the outlet of pump 26 and to the fluid conduits 38, 40. In a preferred form, the control valve assembly 36 includes a three-position directional control valve 46 operated under the influence of a foot pedal 48 preferably located in the operator station 18 of the wheel loader 10. For example, the directional control valve 46 may be movable between a first or neutral position, leftward to a second operating or lift position, and rightward to a third operating or lowering position.

When directional control valve 46 is disposed in a neutral position, pump 26, fluid conduit 38, and fluid conduit 40 are all isolated from one another to enable the hydraulic cylinders 32, 34 to hold or maintain the implement 20 in a selected elevational position relative to the frame 12. When control valve 46 is shifted to a lift position, pump 26 is in fluid communication via conduit 38 with the head end chamber 42 of each hydraulic cylinder 32, 34 and the rod end chamber 44 of each cylinder 32, 34 is open to exhaust via conduit 40, thereby enabling the hydraulic cylinders 32, 34 to raise the implement 20 relative to the frame 12. When control valve 46 is shifted to a lowering position, pump 26 is in fluid communication via conduit 40 with the rod end chamber 44 of each hydraulic cylinder 32, 34 and the head end chamber 42 of each cylinder 32, 34 is open to exhaust via conduit 38 thereby enabling the hydraulic cylinders 32, 34 to lower the implement 20 relative to the frame 12. Such forms of hydraulically operated circuitry are well known, and various other circuits may be used without detracting or departing from the spirit and scope of the present invention.

The tilt circuitry of hydraulic system 25 includes a hydraulic cylinder 52 powered by pump 26 and operably connected to the frame 12 and implement 20 for tilting the implement relative to the frame about a generally horizontal axis in response to fluid flow therethrough. As shown, hydraulic cylinder 52 is arranged above hydraulic cylinders 32, 34 and is selectively controlled by a tilt control valve assembly 56, which is connected to the pump 26.

The hydraulic cylinder 52 is linearly distendable and operable in response to fluid flows at respective head and rod end chambers 62 and 64. In a most preferred form, the head and rod end chambers 62 and 64 of the hydraulic cylinder 52 each define a fluid receiving chamber whose volume controls the tilt position of the implement 20 relative to the frame 12 or lift arms 22.

As shown in FIG. 1, a conventional linkage mechanism 61 including a pivotally mounted lever arm 63 carried between the lift arms 22 interconnects the hydraulic cylinder 52 and the implement 20. As will be understood, extension/retraction of cylinder 52 causes the lever arm 63 to pivot, thereby tilting the implement 20 about its horizontal axis to dump materials therefrom.

Returning to FIG. 2, control valve assembly 56 is connected to the outlet of pump 26 and to fluid conduits 58 and 60. In a preferred form, the control valve assembly 56 includes a three-position directional control valve 66 operated under the influence of a manually operated controller 68 preferably located in the operator station 18 of the loader. The control valve 66 may be movable between a first or neutral position in which the implement 20 is held against tilting, leftward to a second operating or “dump” position and rightward to a third operating position.

When control valve 66 is positioned in a neutral position, pump 26, fluid conduit 58, and fluid conduit 60 are all isolated from one another to enable the hydraulic cylinder 52 to hold or maintain the implement 20 in a selected tilted position relative to the frame 12 or lift arms 22. When control valve 66 is shifted to the “dump” position, pump 26 is fluidly connected via conduit 60 with the rod end chamber 64 of the hydraulic cylinder 52 and head end chamber 62 is open to exhaust thereby enabling retraction of the hydraulic cylinder 52 in a manner moving the conventional linkage mechanism 61 to tilt the implement 20 about its horizontal axis and “dump” materials therefrom.

When control valve 66 is shifted to the third position, pump 26 is connected via conduit 58 with the head end chamber 62 of the hydraulic cylinder 52 and the rod end chamber 64 is open to exhaust thereby enabling extension of the hydraulic cylinder 52 to conventional linkage mechanism 61 to tilt the implement 20 in an opposite direction about the horizontal axis of the implement 20. As mentioned above, such forms of hydraulically operated circuits are well known and various other circuits including more than one hydraulic cylinder may be used without departing or detracting from the spirit and scope of the present invention.

The hydraulic system 25 further includes lift arm chatter deterring accumulator 70. The accumulator 70 is precharged to an appropriate operating pressure. In a most preferred form of the invention, accumulator 70 is a conventional nitrogen/oil accumulator. Accumulator 70 is directly connected to the fluid conduit 38 and fluidly connected to the base chamber 42 of the lift cylinders 32, 34. In a preferred form of the invention, the rod end chamber 44 of the hydraulic cylinder 32, 34 is not connected to the reservoir 28 when the loader 10 or lift arm 22 control valve 46 spool is in neutral. This allows the operator to apply down pressure on the implement 20 for ground penetration by tilting the implement 20 while the lift arm control valve 46 is in neutral and prevent lift arm chatter without having to turn the hydraulic system 25 on or off at the appropriate time.

As schematically represented in FIG. 2, in a preferred form of the invention, shifting movement of the directional control valve 46 of control valve assembly 36 is controlled by foot pedal 48, which is mechanically linked to the spool of directional control valve 46. In operation, the position of the directional control valve spool controls the flow of hydraulic fluid to actuate hydraulic cylinders 32, 34.

During operation of the loader, selective movement of foot pedal 48 and controller 68 will position the respective directional control valves 46 and 66 thereby controlling fluid flow to the hydraulic cylinders 32, 34 and 52. As will be appreciated, fluid flow in conduits 38, 40 regulate operation of the hydraulic cylinders 32, 34 in a manner controlling elevation of the implement 20 relative to the frame 12. Fluid flow in conduits 58, 60 regulate operation of the hydraulic cylinder 52 and thereby the tilt position of the implement 20 about its horizontal axis. In a neutral position, control valve assemblies 36 and 56 inhibit flow through the conduits leading therefrom and thereby hold or maintain the implement 20 in an adjusted position relative to the frame.

During operation of the wheel loader 10, and in other types of hydraulically operated load handling equipment, as the lift arm control valve spool shifts from a position to raise the implement 20 to a neutral position in which the implement 20 is neither raised nor lowered to a position in which the implement 20 is lowered, or from the lowered position to the neutral position and then to the raised position, or into or out of the neutral position, the quick movement of the lift arms 22 can cause the front tires 16 to deflect and then rebound similar to a spring.

As the loader 10 or other vehicle begins to bounce, the operator's foot can move the foot pedal 48 in sync with the bounce. This can lead to inadvertent stroking of the directional control valve 46 spool, leading to a resonance condition and uncontrolled lift arm movement.

The accumulator 70 of the present invention effectively disconnects the mass of the lift arms 22 and implement 20 from the mass of the vehicle chassis. Therefore, the natural frequency of the lift arms 22 and implement 20 is different than the natural frequency of the frame 12, and rather than leading to a resonance condition, movement of the lift arms 22 tends to cancel the bouncing of the frame 12.

The accumulator 70 is connected directly to the head end chambers 42 of the hydraulic cylinders 32, 34 through the fluid conduit 38 at all times. There is no valve or other hydraulic device between the accumulator 70 and the head end chambers 42 of the hydraulic cylinders 32, 34.

Preferably, the rod end chamber 44 is not connected to the reservoir 28 when the spool of the directional control valve 46 is in the neutral position. Therefore, while the accumulator 70 permits some movement of the hydraulic fluid out of and into the head end chamber 42, the movement of the hydraulic fluid into and out of the rod end chamber 44 is deterred. This also deters lift arm chatter.

Also, because the rod end chamber 44 is not connected to the reservoir 28 when the spool of the directional control valve 46 is in the neutral position, the operator can apply down pressure on the implement 20 for ground penetration by tilting the implement 20. If the rod end chamber 44 were connected to the reservoir 28, down pressure on the implement 20 would tend to force hydraulic fluid out of head end chamber 42 and into the accumulator 70, the hydraulic fluid in rod end chamber 44 being replenished from the reservoir 28. With the rod end chamber 44 isolated from the reservoir 28, the hydraulic fluid in the rod end chamber 44 cannot be replenished and, as the volume of the rod end chamber 44 tends to increase, the pressure in the rod end chamber 44 is reduced and tends to prevent the hydraulic fluid from being force out of the head end chamber 42 and into the accumulator 70.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A hydraulic system for vertically positioning an implement relative to a frame of a vehicle comprising:
a pressurized fluid source;
a hydraulic cylinder for vertically positioning the implement; the hydraulic cylinder having a base end chamber and a rod end chamber, wherein the hydraulic cylinder raises the implement when the pressure in one of the base and rod end chambers exceeds the pressure in the other end chamber and lowers the implement when the pressure in the other end chamber exceeds the pressure in the one end chamber;
a reservoir for receiving excess fluid;
a control valve for controlling flow of the pressurized fluid to the base end chamber or rod end chamber; wherein the control valve has a spool that controls the flow of the pressurized fluid depending on which of three positions the spool is in, a first position to raise the implement, a second neutral position in which the implement is neither raised nor lowered and a third position in which the implement is lowered;
a conduit connecting the pressurized fluid source to the control valve;
a conduit connecting the control valve to the reservoir;
a conduit connecting the control valve to the base end chamber;
a conduit connecting the control valve to the rod end chamber; and
an accumulator directly connected to the conduit connecting the control valve to the one end chamber.

2. The hydraulic system of claim 1, further comprising a foot pedal mechanically connected to the control valve spool for positioning the control valve spool.

3. The hydraulic system of claim 1, wherein the other end chamber is isolated from the reservoir when the control valve is in the second neutral position.

4. The hydraulic system of claim 2, wherein the other end chamber is isolated from the reservoir when the control valve is in the second neutral position.

5. A wheeled vehicle comprising a hydraulic system for vertically positioning an implement relative to a frame of the wheeled vehicle, the hydraulic system comprising:
a pressurized fluid source;
a hydraulic cylinder for vertically positioning the implement; the hydraulic cylinder having a base end chamber and a rod end chamber, wherein the hydraulic cylinder raises the implement when the pressure in one of the head and rod end chambers exceeds the pressure in the other end chamber and lowers the implement when the pressure in the other end chamber exceeds the pressure in the one end chamber;
a reservoir for receiving excess fluid;
a control valve for controlling flow of the pressurized fluid to the base end chamber or rod end chamber; wherein the control valve has a spool that controls the flow of the pressurized fluid depending on which of three positions the spool is in, a first position to raise the implement, a second neutral position in which the implement is neither raised nor lowered and a third position in which the implement is lowered;
a conduit connecting the pressurized fluid source to the control valve;
a conduit connecting the control valve to the reservoir;
a conduit connecting the control valve to the base end chamber;
a conduit connecting the control valve to the rod end chamber; and
an accumulator directly connected to the conduit connecting the control valve to the one end chamber.

6. The wheeled vehicle of claim 5, further comprising a foot pedal mechanically connected to the control valve spool for positioning the control valve spool.

7. The wheeled vehicle of claim 5, wherein the other end chamber is not connected to the reservoir when the control valve is in the second neutral position.

8. The wheeled vehicle of claim 6, wherein the other end chamber is not connected to the reservoir when the control valve is in the second neutral position.

9. The wheeled vehicle of claim 5, further comprising pneumatic tires supporting the frame of the wheeled vehicle.

10. The wheeled vehicle of claim 6, further comprising pneumatic tires supporting the frame of the wheeled vehicle.

11. The wheeled vehicle of claim 7, further comprising pneumatic tires supporting the frame of the wheeled vehicle.

12. The wheeled vehicle of claim 8, further comprising pneumatic tires supporting the frame of the wheeled vehicle.

13. A method of deterring lift arm chatter of a wheeled vehicle having a lift arm and a vertically positionable implement attached to the lift arm, the method comprising providing the wheeled vehicle with a hydraulic system, wherein the hydraulic system comprises (a) a pressurized fluid source, (b) a hydraulic cylinder for vertically positioning the implement, the hydraulic cylinder having a base end chamber and a rod end chamber, wherein the hydraulic cylinder raises the implement when the pressure in one of the base and rod end chambers exceeds the pressure in the other end chamber and lowers the implement when the pressure in the other end chamber exceeds the pressure in the one end chamber, (c) a reservoir for receiving excess fluid, (d) a control valve for controlling flow of the pressurized fluid to the base end chamber or rod end chamber, wherein the control valve has a spool that controls the flow of the pressurized fluid depending on which of three positions the spool is in, a first position to raise the implement, a second neutral position in which the implement is neither raised nor lowered, and a third position in which the implement is lowered, (e) a conduit connecting the pressurized fluid source to the control valve, (f) a conduit connecting the control valve to the reservoir, (g) a conduit connecting the control valve to the base end chamber, (h) a conduit connecting the control valve to the rod end chamber, and (i) an accumulator directly connected to the conduit connecting the control valve to the one end chamber.

14. The method of claim 13, wherein the hydraulic system further comprises a foot pedal mechanically connected to the control valve spool for positioning the control valve spool.

15. The method of claim 13, wherein the other end chamber is isolated from the reservoir when the control valve is in the second neutral position to allow down pressure on the implement for ground penetration and to deter implement chatter without having to connect and isolate the accumulator from the hydraulic system.

16. The method of claim 14, wherein the other end chamber is isolated from the reservoir when the control valve is in the second neutral position to allow down pressure on the implement for ground penetration and to deter implement chatter without having to connect and isolate the accumulator from the hydraulic system.

17. The method of claim 13, wherein the wheeled vehicle comprises pneumatic tires that deflect and rebound upon quick movement of the lift arm capable of causing the operator's foot to move relative to the foot pedal leading to a resonance condition and uncontrolled lift arm movement.

18. The method of claim 14, wherein the wheeled vehicle comprises pneumatic tires that deflect and rebound upon quick movement of the lift arm capable of causing the operator's foot to move relative to the foot pedal leading to a resonance condition and uncontrolled lift arm movement.

19. The method of claim 15, wherein the wheeled vehicle comprises pneumatic tires that deflect and rebound upon quick movement of the lift arm or implement capable of causing the operator's foot to move relative to the foot pedal leading to a resonance condition and uncontrolled lift arm movement.

20. The method of claim 16, wherein the wheeled vehicle comprises pneumatic tires that deflect and rebound upon quick movement of the lift arm capable of causing the operator's foot to move relative to the foot pedal leading to a resonance condition and uncontrolled lift arm movement.
